(19) United States
(12) Patent Application Publication
(10) Pub. No.: US 2015/0039520 A1
(43) Pub. Date: Feb. 5, 2015

(54) PERSONAL SECURE INFORMATION DEVICE (PSID)

(71) Applicant: Mark T. Polivka, McKinney, TX (US)

(72) Inventor: Mark T. Polivka, McKinney, TX (US)

(21) Appl. No.: 13/958,275

(22) Filed: Aug. 2, 2013

(51) Int. Cl. G06Q 20/20; G06Q 20/40; G06Q 20/32

(52) U.S. Cl. CPC G06Q 20/206; G06Q 20/3278; G06Q 20/401; G06Q 2220/00
USPC 705/73; 705/18; 705/44

(57) ABSTRACT

A secure data transmission device: employs a proprietary arrangement of individualized encodable micro-machined electromagnets embedded in a compact, plastic (or apt substrate) which insulates each electromagnet from one another. The electromagnets mimic the magnetic strip on a credit card, but have the capability to temporarily capture data, and then transmit said data to be read by a magstripe terminal. The electromagnetic device can receive, and momentarily capture a variety of data, depending on which digital data is chosen by user. It then converts that data it to an analog signal, and then by using such components as microphone amplifier, a digital-to-analog converter, and microprocessor in the mobile device, transmits that data to the secure information device, which can write that data to a magnetic card terminal. The secure transmission device can be rewritten over and over again each time the user has a separate transaction, using different transaction data.

### CONTINUITY

This is a Utility Patent Application of U.S. Provisional Patent Application No. 61/679,004 filed on Aug. 2, 2012, and priority is claimed thereto.

### FIELD OF THE PRESENT INVENTION

The embodiment of this invention is a proprietary arrangement of individualized encodable micro-machined electromagnets embedded in a compact, portable, plastic, or apt substrate which insulates them from one another: this array is formed to meet ISO/IEC standard 7811 for merchant transactions; henceforth the invention will be referred to as PSID. The (PSID's) proprietary encodable electromagnets are embedded in an apt substrate mimic the magnetic strip on a credit card, but have the capability to be individually encrypted read, temporarily capture, and then rewrite secure data. The PSID utilizes existing (“Host) technology and power to accomplish these functions.

### BACKGROUND OF THE PRESENT INVENTION

In recent years, increasing interest has been paid to the development of “smart-device” technologies: IPhone, IPad, Android etc. which allow individuals to securely carry with them confidential information in a package roughly the size of a traditional cell phone or similar platform. This information may include, for example: identification information, allowing public and private institutions to verify the identity of the bearing individual, insurance information, medical information, allowing medical personnel to identify the individual's medical needs and a myriad other valuable data, such as credit card, flight, or secure access information that is often needed.

Current smart-phone or similar development efforts have focused on state-of-the-art technologies, such as radio frequency identification (RFID) or more recently Near Field Technology (NFT) which conventionally employs a secure element, and is also referred to as Near Field Communications (NFC). The RFID and NFT approach has substantial appeal, since information can easily be transferred wirelessly between a “smart device” and an associated Point of Sale (POS) system. However, these state-of-the-art approaches are still subject to a number of significant drawbacks. Primary among these is the inability of newer technologies to efficiently mesh with legacy information transfer and storage technologies. Moreover, techniques using wireless broadcast technologies, such as RFID and NFT, remain vulnerable to Phising, electronic eavesdropping, and other security breaches.

### SUMMARY OF THE PRESENT INVENTION

The PSID, on the other hand, is comprised of individualized encodable electromagnets embedded in a insulating strip that can be programed depending on the data that is input. The (PSID imitates the function of the bar magnets, but can receive, and momentarily capture a variety of data depending on current flow, voltage, and frequency from the (“Host Device”) (i.e., smart phone). The PSID communicates with the (“Host Device”) through an articulated outlet jack adapted to be inserted into the microphone input of (“Host Device”). The (“Host Device”) takes digital data chosen by user, which is input into the (“Host memory”, converts that data it to an analog signal, and then by using such components as microphone amplifier, a digital-to-analog converter, and microprocessor already resident in the (“Host Device”), and momentarily captures that data. PSID then can be rewritten over and over again each time the user has a separate transaction, using different transaction data.

A magstripe card terminal, like that issued by merchants to determine if your conventional credit card will pay for what you're charging, will then be able to read and write this data captured on the PSID. The embodiment of the PSID differs from a conventional magnetic stripe, or magstripe, typical on the back of any credit card. The magstripe on a conventional credit card is made up of tiny iron-based magnetic particles in a plastic-like film. Each particle is really a very tiny bar magnet about 20 millionths of an inch long. The magstripe can be “written” because the tiny bar magnets can be magnetized in either a North or South Pole direction. The magstripe on the back of a credit card is very similar to a piece of cassette tape fastened to the back of a card. Analog Data can only be written to this magstripe by a separate analog write head; data is retained by the magnetized particles until rewritten by a separate devices record head.

The PSID, on the other hand, is comprised of individualized encodable electromagnets embedded in an insulating strip that can be programed depending on the data that is input. The (PSID imitates the function of the bar magnets, but can receive, and momentarily capture a variety of data depending on current flow from (“Host Device”) (i.e., smart phone). The PSID communicates with the (“Host Device”) through an articulated outlet jack adapted to be inserted into the microphone input of (“Host Device”). The (“Host Device”) takes digital data chosen by user, which is input into the (“Host memory”, converts that data it to an analog signal, and then by using such components as microphone amplifier, a digital-to-analog converter, and microprocessor already resident in the (“Host Device”), and momentarily captures that data. PSID then can be rewritten over and over again each time the user has a separate transaction, using different transaction data.

### BRIEF DESCRIPTION OF DRAWINGS

For a more complete understanding of the present invention, and the advantages thereof, reference is now made to the following descriptions taken in conjunction with the accompanying drawings, in which:

FIG. 1A is a variable view plan of illustrations showing the external features of PSID in Use Variations: By articulated jack in 102, by manufacturer at assembly, or attached, concealed, in an aftermarket hard case 101, according to the principles of the present invention.

FIG. 1B-1C is a conceptual diagram of Data access fingerprint reader and Log-In Screen that verifies user to power PSID.

FIGS. 2A-2B collectively are a representation of how PSID can be used with (“Host”) and current Point of Sale Devices.

FIGS. 3A-3B is a view of an electrical schematic diagram of electromagnetic permalloy display and subsystem suitable for use in the embodiment of PSID with explanation.

FIG. 4 depicts a view of the present invention from the front, along with an example of the magnetic stripe as employed by the present invention.

### DETAILED DESCRIPTION OF THE PRESENT INVENTION:

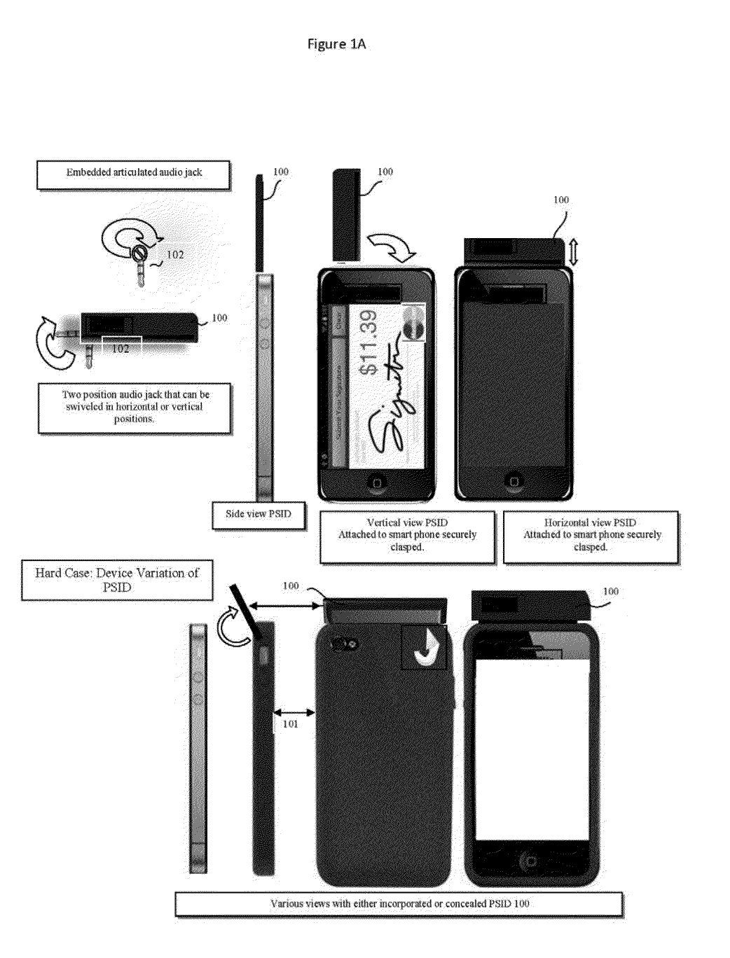

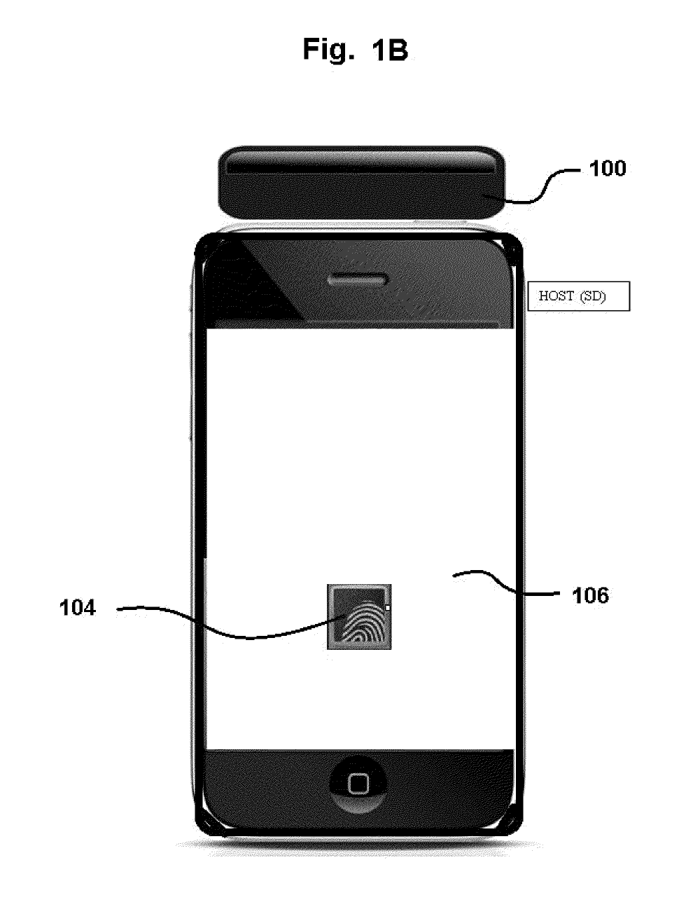

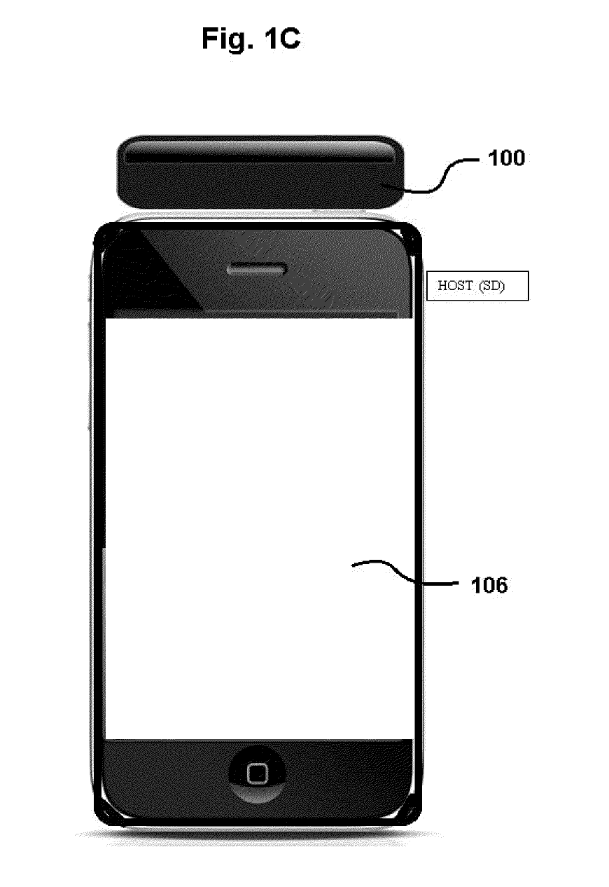

The principles of the present invention and their advantages are best understood by referring to the illustrated embodiment depicted in FIGS. 1-3, in which like numbers designate like parts.

FIG. 1A is an external view of PSID 100 embodying the principles of the present invention. Generally, 100 is coupled with a proprietary software program that utilizes secure internal (“Host”) memory, which stores personal information concerning an authorized user that is accessible only after user verification on (“Host”)

The illustrated embodiment of PSID 100, which is described in further detail below, operates from sufficient current from (Host) internal batteries. PSID 100 also includes access to (“Host”) with Articulated Multi-position Embedded Audio Jack 102.

A fingerprint reader 104, can be provided to verify the identification of the bearer of PSID 100. User interface 106 on (“Host”) wedded with PSID allows for the input of a PIN, Password, facial recognition, or similar code, as desired to provide an extra level of security, as well allows the user to select the internally-stored information accessible after user verification.

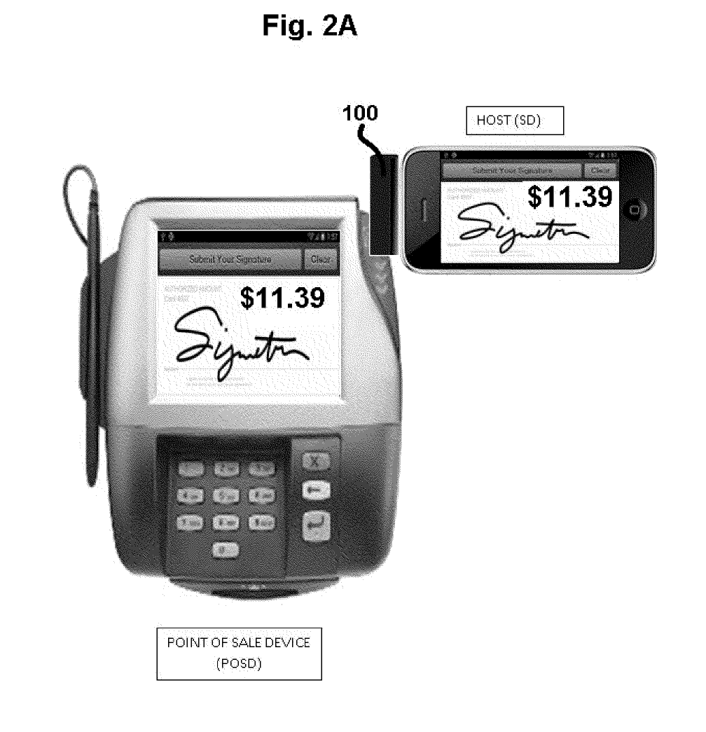

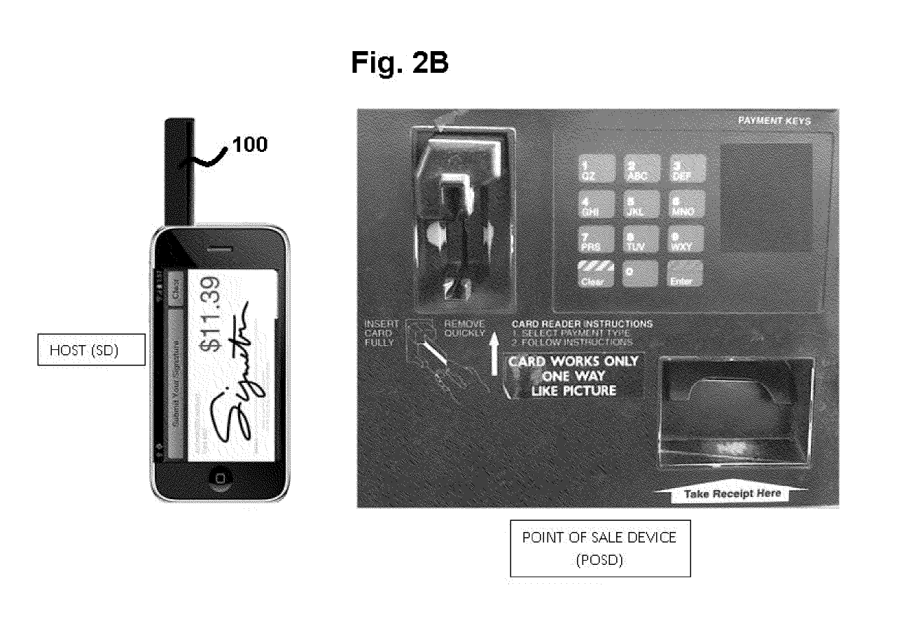

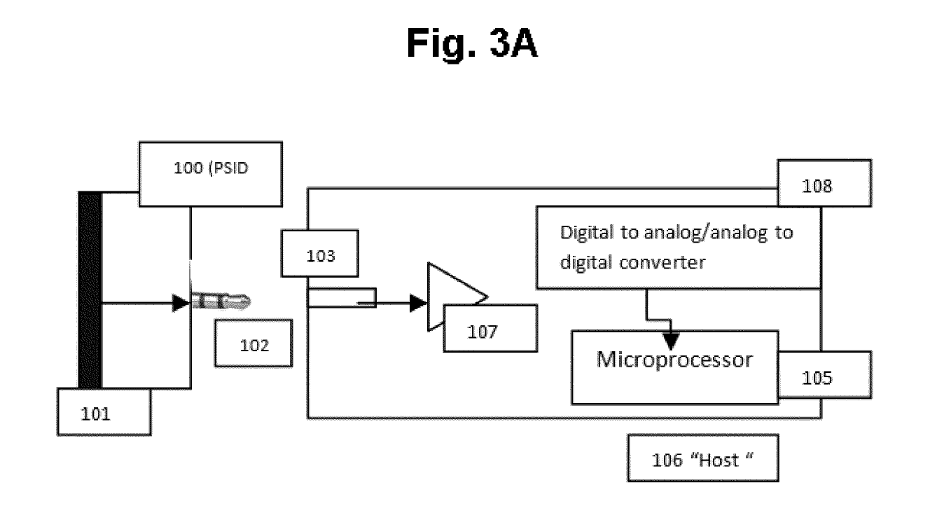

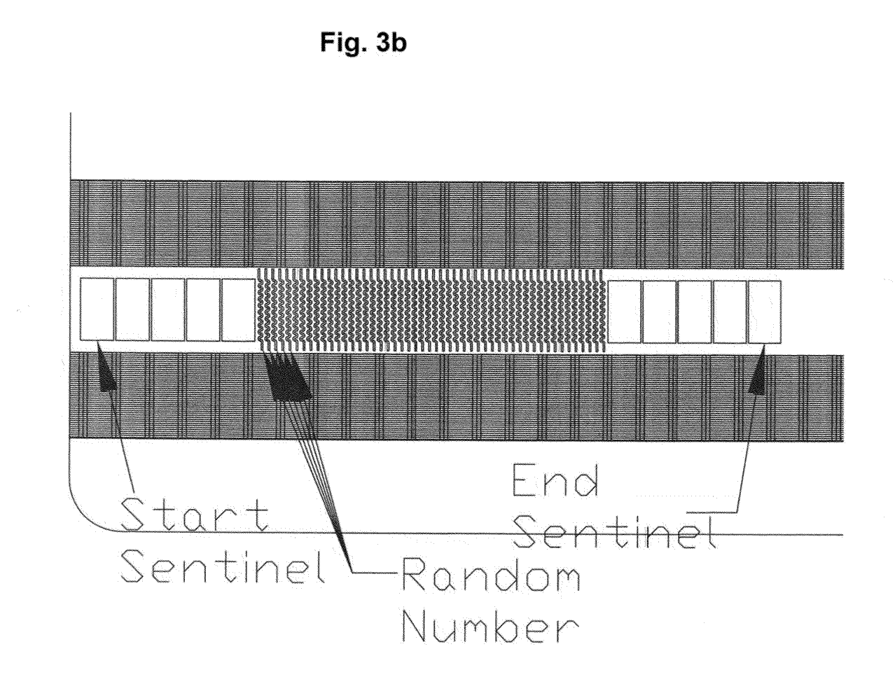

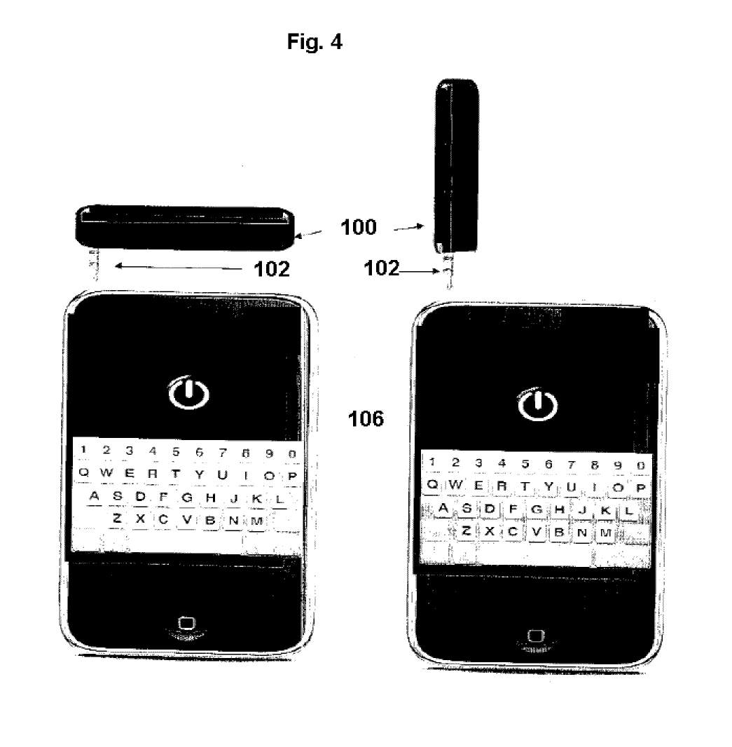

As also discussed further below, an electromagnetic stripe 108, FIG. 3A-B, allows information to be read from, or written to, PSID 100. Advantageously, electromagnetic stripe 108 allows PSID 100 to be used with existing card reading systems, FIGS. 2A-B, such as those used to read traditional credit cards.

Generally, PSID 100 is constructed using a plastic or other suitable substrate. Magnetic stripe 108, FIG. 3A-B, is preferably laid upon an array of micro-machined electromagnets, which are driven by (“Host”) microprocessor to program/write/encode the magnetic stripe 108, FIG. 3A-B, with the accessible information, and erase information after a short time.

More particularly, the electromagnets are preferably micro-machined copper coils with a Permalloy core each connected to a bidirectional driver. Each coil is driven by a small pulse of current, 1 milliAmp or less, to produce the magnetic field to magnetize the stripe, one bit at a time. The length and width of the electromagnets is dictated by specification ISO/IEC7811 for standard magnetic stripe cards.

Preferably, three or more rows of individual micro-machined electromagnets are used to provide three tracks able to produce sufficient magnetic field to magnetize a 300 Oersted magnetic stripe with the accessible information. Each coil length depends on the track data density. In the illustrated embodiment, there is one coil/electromagnet per each bit of logic “One” and two coils/electromagnets per each bit of logic “Zero”.

In the preferred embodiment of PSID 100, fingerprint information is permanently programmed into a “write once memory”, discussed further below. Programming of user biometric (fingerprint) data is performed at user download of wedded software, using conventional memory programming. FIGS. 1A-1C is an illustration of Finger print system on (“Host”) and user interface with (QWERTY) keyboard. Dataflash memory, with coupled software, also stores the confidential user information, such as a user account number, user identification number, social security number, premises access number, insurance policy number, and similar confidential information on (“Host”). Additionally, the Electromagnets of the present invention are to preferably be micro-machined copper coils with a permalloy core each connected to a bidirectional driver; each coil to be driven by a small pulse of current, 1 milliAmps or less, to produce the magnetic field to magnetize the stripe, one bit a time. The length and width of the electromagnets is dictated by the specification ISO/IEC7811 for standard magnetic stripe cards. Each coil length depends on the track data density. There is one coil/electromagnet per each bit of logic “One” and two coils/electromagnets per each bit of logic “Zero”

FIG. 3A-B is the embodiment of the electromagnetic array in PSID with written clarification.

The invention will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

### D. (PSID) Circuit Design

1. (PSID) powered by (“Host”)
2. Data secured by fingerprint reader, pin, face recognition, password etc. on (“Host”) which is permanently programmed into (“Host”) memory with contains user biometric (fingerprint) and account information etc.
3. Three or more rows of micro-machined electromagnets for all tracks of the card able to produce sufficient magnetic field to magnetize a 300 Oersted magnetic stripe with the account Data. The electromagnets to be copper coils with permalloy core connectable to the other circuits in (SD Host). Connection techniques: audio jack, blue tooth, etc. to be determined.
4. Coils can be manufactured in individual chips or small group chips optimized for the best yield, using any suitable insulating substrate.
   a. Theoretical design based on simulation results: Verification of feasibility of supplying sufficient current. Tradeoffs between the size of the coils and the magnitude of the drive current.
   b. Design of prototypes to verify the theoretical results. This is a must step since computer simulations at this small scale is often misleading due to the approximations of properties of thin films of materials, m manufacturability of large number of electromagnets at acceptable yields, manufacturability of the entire card assembly:
   c. Assembly issues related to connecting the electromagnets to the rest of the circuitry. Current technology of connecting these coils is gold wire bonding References:
2. Strip Calculations,

### Security:

1. Temporary Activation by fingerprint reader located on the Smart phone, pad etc. Device (“Host”)
   a. (PSID)Activated with for short duration (about 20 seconds) to allow reader to read account information followed by deactivation, to erase the account information in order to prevent unauthorized access if (PSID) or (“Host”) has been lost or stolen.
2. Fingerprint permanently programmed into the (“Host”) burned into the “write once memory”, non-reprogrammable
3. Programming of user biometric data (fingerprint) to be performed at initial soft-ware download date.
4. PSID is powered by (“Host”) internal battery
   a. Re-chargeable
   b. Non-rechargeable
      B. Useable with current Point of Sale Magnetic Stripe Card readers
1. Similar to a standard magnetic stripe card, (PSID) to be used with existing magnetic stripe readers:
   a. Activate (PSID) by pressing the start switch and reading the user finger print
   b. Swiping (PSID) through the magnetic card reader.

### C. Construction:

1. Plastic or similar Substrate
2. Magnetic Stripe used for existing swipe readers
   a. Magnetic stripe lay upon an array of micro-machined electromagnets. Electromagnets to be driven by the (SD Host) microprocessor to program/write/encode the magnetic stripe with the account information, and erase information after a short time

### Magnetic Stripe Calculations:

### Bits per Character Bits Per Inch

Track 1—IATA 79 Alpha char: 6 Data+1 Parity (odd), 210 bpi (bits per inch)
Track 2—ABA 40 BCD char: 4 Data+1 Parity (odd), 75 bpi
Track 3—Thrift 107 BCD char: 4 Data+1 Parity (odd), 210 bpi

### Track 1 Specific Layout:

zeros|SS|FC|Primary Acct (19 characters max)|Name (26 characters max)|FS|other data|ES|LRC|zeros

### Track 2 Specific Layout:

zeros|SS|Primary Acct (19 characters max)|FS|other data|ES|LRC|zeros

### Size Calculations:

| | | | length of | | | length of |
|---|---|---|---|---|---|---|
| | | Data bits | one bit | length of | length of | each magnet |
| data Bits | zero bits | length (in) | (in) | one bit (mm) | one bit (um) | (um) |
| Track1: 553 | ?TBD | 2.6333333 | 0.004762 | 0.00018748 | 0.1874765654 | 0.0937382827 |
| Track2: 200 | ?TBD | 2.6666667 | 0.013333 | 0.00052493 | 0.5249343832 | 0.2624671916 |
| Track3: 535 | ?TBD | 2.547619 | 0.004762 | 0.00018748 | 0.1874765654 | 0.0937382827 |

I claim:

1. A secure information transmission and payment device for a mobile device comprising:
a magnetic stripe, said magnetic stripe housed within a substrate;
micro-machined electromagnets;
wherein said micro-machined electromagnets are disposed under said magnetic stripe and are configured in an array;
wherein said micro-machined electromagnets write secure data to said magnetic stripe;
an articulated multi-position embedded audio jack,
wherein said articulated multi-position embedded audio jack is a conduit providing electricity to said micro-machined electromagnets from a battery of the mobile device;
wherein said articulated multi-position embedded audio jack is configured to interface with the mobile device via an application;
wherein said articulated multi-position embedded audio jack provides for said micro-machined electromagnets to connect to a network via an internet connection on said mobile device through said application;
a fingerprint reader, said fingerprint reader configured to authenticate a user prior to providing the user access to said application; and
wherein said magnetic stripe interfaces with a Point-of-Sale terminal to convey said secured data written to said magnetic stripe by said micro-machined electromagnets.

2. The device of claim 1, wherein said mobile device is one of the following: a cell phone, smartphone, tablet computer, iPad™, network-connected digital audio player, and other internet connected devices equipped with an audio port.

3. The device of claim 2, wherein said audio port is powered and data-capable.

4. The device of claim 1, wherein said magnetic stripe is programed with said secure data via said micro-machined electromagnets; and
wherein said micro-machined electromagnets are arranged in a proprietary, individualized manner, and are encodable via said application on the mobile device.

5. The device of claim 2, wherein said substrate is composed of plastic.

6. The device of claim 4, wherein said micro-machined electromagnets are embedded within the substrate and are formed to meet ISO/IEC standard 7811 for merchant transactions.

7. The device of claim 5, wherein said substrate is portable and sized according to the width of the mobile device.

8. The device of claim 1 wherein said micro-machined electromagnets are individually encrypted.

9. The device of claim 1, wherein said articulated multi-position embedded audio jack is capable of sending a signal from said micro-machined electromagnets to receive and transmit data to and from the mobile device.

10. The device of claim 1, wherein said micro-machined electromagnets can read, temporarily capture, and then rewrite said secure data.

11. The device of claim 1, wherein said micro-machined electromagnets employ existing “Smart Device” (“Host”) technologies, network connection, and power of the mobile device.

12. The device of claim 1 wherein said micro-machined electromagnets are individually programmable.

13. The device of claim 3 wherein said articulated multi-position embedded audio jack can be articulated into multiple positions.

14. The device of claim 1 wherein the electromagnets are embedded in a compact, portable, and plastic substrate, providing insulation between said electromagnets.

15. The device of claim 1 wherein said micro-machined electromagnets are configured to receive signals that vary in intensity to communicate the functionality of intended signal to said point of sale terminal (POS).

16. The device of claim 9 wherein the articulated multi-position embedded audio jack extends from said substrate.

17. A secure data transmission device for a mobile device comprising:
at least one encodable micro-machined electromagnet;
wherein said at least one encodable micro-machined electromagnet is embedded in a compact, portable, and plastic substrate;
wherein said at least one encodable micro-machined electromagnet is formed to meet ISO/IEC standard 7811 for merchant transactions;
an articulated multi-position embedded audio jack,
wherein said articulated multi-position embedded audio jack extends from said substrate;
wherein said articulated multi-position embedded audio jack is configured to interface with said at least one encodable micro-machined electromagnet and the mobile device via an audio port on the mobile device;
wherein said articulated multi-position embedded audio jack is a conduit for transmitting electricity to said at least one encodable micro-machined electromagnet from a battery housed within the mobile device;
wherein said articulated multi-position embedded audio jack is a conduit for transmitting secured data to said at least one encodable micro-machined electromagnet from a network connection of the mobile device; and
wherein said at least one encodable micro-machined electromagnet can be arrayed into different formats and number.

18. The device of claim 1 wherein the electromagnets can be arrayed into different formats and number.

19. The device of claim 10, wherein said micro-machined electromagnets employ existing “Smart Device” (“Host”) technologies, network connection, and power of the mobile device.

20. The device of claim 6, wherein said micro-machined electromagnets can read, temporarily capture, and then rewrite said secure data.
